(19) United States
(12) Patent Application Publication
(10) Pub. No.: US 2017/0155482 A1
(43) Pub. Date: Jun. 1, 2017

(54) METHOD AND APPARATUS FOR RESOURCE ALLOCATION BETWEEN MULTIPLE CELLS BASED ON COORDINATED MULTIPOINT

(71) Applicant: Alcatel Lucent, Boulogne Billancourt (FR)

(72) Inventors: Zhilan Xiong, Shanghai (CN); Jun Wang, Shanghai (CN); Min Zhang, Swindon (GB)

(73) Assignee: Alcatel Lucent, Boulogne Billancourt (FR)

(21) Appl. No.: 15/127,648

(22) PCT Filed: Mar. 16, 2015
(86) PCT No.: PCT/IB2015/000513

§ 371 Date: Sep. 20, 2016

(30) Foreign Application Priority Data
Mar. 21, 2014 (CN) 201410108469.7

(51) Int. Cl. H04L 5/00; H04W 24/06; H04W 72/08

(52) U.S. Cl. CPC H04L 5/0035; H04W 72/082; H04W 24/06

(57) ABSTRACT

An object of the invention is providing methods, devices and a System for resource allocation between multiple cells based on coordinated multipoint. One or more second devices determines, based on one or more coordinated multipoint simulation scenarios, benefit metric information corresponding to the coordinated multipoint simulation scenario; and the first device determines resource allocation information corresponding to an associated device based on the benefit metric information. Compared with the prior art, the present invention realizes resource allocation between multiple cells in a centralized coordinated multipoint architecture or a distributed coordinated multipoint architecture based on the defined benefit metric information and the proposed exchange mode of benefit metric information, particularly coordinated multipoint resource allocation in a non-ideal backhaul status, thereby mitigating inter-cell interference and meanwhile guaranteeing benefits of multiple cells.

### FIELD OF THE INVENTION

The present invention relates to the field of communication, and in particular to the technology of resource allocation between multiple cells based on coordinated multipoint.

### BACKGROUND OF THE INVENTION

Coordinated multipoint (CoMP) transmission has been widely studied in LTE-A (Long Term Evolution-Advanced) with the assumption of ideal backhaul and centralized scheduling. The studies of CoMP in LTE-A mainly focus on X2 signaling enhancement with more realistic network assumptions and non-ideal backhaul. So it becomes an urgent issue to be solved for the skilled in the art that how to allocate resource between multiple cells, so as to mitigate inter-cell interference and guarantee benefits of multiple cells simultaneously.

### SUMMARY OF THE INVENTION

An object of the invention is providing methods, devices and a system for resource allocation between multiple cells based on coordinated multipoint.

According to one aspect of the invention, a method for resource allocation between multiple cells by a first device based on coordinated multipoint is provided, wherein the method comprises:

a. obtaining one or more benefit metric information with respect to a second device, wherein the benefit metric information corresponds to one or more coordinated multipoint simulation scenarios;

b. determining resource allocation information corresponding to an associated device associated with the benefit metric information based on the benefit metric information.

According to another aspect of the invention, a method facilitating resource allocation between multiple cells by a second device based on coordinated multipoint is further provided, wherein the method comprises:

A. determining, based on one or more coordinated multipoint simulation scenarios, benefit metric information corresponding to the coordinated multipoint simulation scenario;

B. transmitting the benefit metric information to a first device.

According to another aspect of the invention, a first device for resource allocation between multiple cells based on coordinated multipoint is further provided, wherein the device comprises:

an obtaining module configured to obtain one or more benefit metric information with respect to a second device, wherein the benefit metric information corresponds to one or more coordinated multipoint simulation scenarios;

an allocation determining module configured to determine resource allocation information corresponding to an associated device associated with the benefit metric information based on the benefit metric information.

According to another aspect of the invention, a second device facilitating resource allocation between multiple cells based on coordinated multipoint is further provided, wherein the device comprises:

a metric determining module configured to determine, based on one or more coordinated multipoint simulation scenarios, benefit metric information corresponding to the coordinated multipoint simulation scenario;

a transmitting module configured to transmit the benefit metric information to a first device.

According to another aspect of the invention, a system for resource allocation between multiple cells based on CoMP is further provided, wherein the system comprises the foresaid first device, and the foresaid second device.

Compared with the prior art, through determining, by one or more second devices, based on one or more coordinated multipoint simulation scenarios, benefit metric information corresponding to the coordinated multipoint simulation scenario, and determining, by the first device, resource allocation information corresponding to an associated device based on the benefit metric information, the present invention realizes resource allocation between multiple cells in a centralized coordinated multipoint architecture or a distributed coordinated multipoint architecture based on the defined benefit metric information and the proposed exchange mode of benefit metric information, particularly coordinated multipoint resource allocation in a non-ideal backhaul status, thereby mitigating inter-cell interference and meanwhile guaranteeing benefits of multiple cells.

Moreover, the present invention may also achieve resource allocation between multiple cells in a centralized coordinated multipoint architecture or a distributed coordinated multipoint architecture through enhancing an existing resource status reporting mechanism to support coordinated multipoint communication in a non-ideal backhaul status, thereby mitigating inter-cell interference and meanwhile guaranteeing benefits of multiple cells.

### BRIEF DESCRIPTION OF THE DRAWINGS

Other features, purposes and advantages of the invention will become more explicit by means of reading the detailed statement of the non-restrictive embodiments made with reference to the accompanying drawings.

FIG. 1(a) shows a schematic diagram of an architecture of a centralized coordinated multipoint system according to one aspect of the present invention;

FIG. 1(b) shows a schematic diagram of an architecture of a distributed coordinated multipoint system according to one aspect of the present invention;

FIG. 2 shows a schematic diagram of a first device and a second device for resource allocation between multiple cells based on coordinated multipoint according to one aspect of the present invention;

FIG. 3 shows a schematic diagram of a first device and a second device for resource allocation between multiple cells based on coordinated multipoint according to a preferred embodiment of the present invention;

FIG. 4 shows a flow diagram of a method for resource allocation between multiple cells based on coordinated multipoint by cooperation of a first device and a second device according to another aspect of the present invention;

FIG. 5 shows a flow diagram of a method for resource allocation between multiple cells based on coordinated multipoint by cooperation of a first device and a second device according to a preferred embodiment of the present invention;

FIG. 6(a) and FIG. 6(b) show a flow diagram of a method for resource allocation between multiple cells based on coordinated multipoint by cooperation of a first device and a second device according to a preferred embodiment of the present invention;

FIG. 7(a) and FIG. 7(b) show a flow diagram of a method for resource allocation between multiple cells based on coordinated multipoint by cooperation of a first device and a second device according to resource status report information according to one preferred embodiment of the present invention.

The same or similar reference signs in the drawings represent the same or similar component parts.

### DETAILED DESCRIPTION OF THE INVENTION

Below, details of the invention will be further provided in combination with the accompanying drawings.

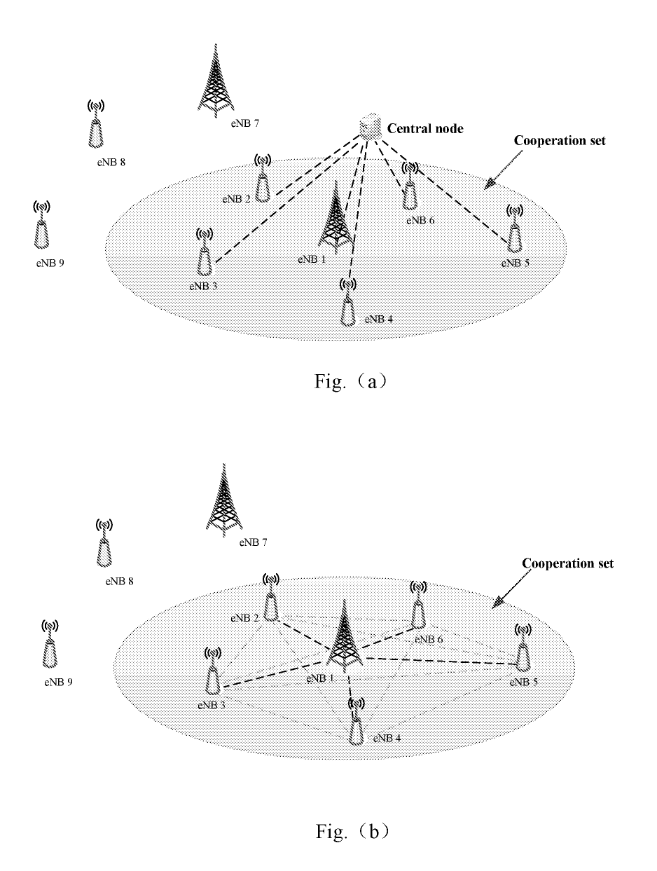

FIG. 1(a) shows a schematic diagram of an architecture of a centralized coordinated multipoint system according to one aspect of the present invention; eNB1 (evolved base station 1) acts as a central node, while eNB2-eNB7 are neighboring nodes of the eNB1 and may act as cooperation nodes corresponding to the central node. In other words, the eNB2-eNB7 are a coordination set corresponding to the central node. Therefore, all of the eNB2-eNB7 need to communicate with the central node to send benefit metric information (BM) corresponding to themselves to the central node, such that the central node performs resource scheduling between multiple coordination nodes based on the benefit metric information. Here, those skilled in the art should understand that the central node may also be other device capable of performing information collection and resource scheduling function independent of eNB1, thereby taking one or more base stations as the central node, respectively, to perform information collection and resource scheduling based on the current central node and the corresponding coordination set.

FIG. 1(b) shows a schematic diagram of an architecture of a distributed coordinated multipoint system according to one aspect of the present invention. eNB1 to eNB7 are adjacent to each other to form a coordination set. Each node may act as its own central node and takes one or more adjacent nodes as coordination nodes. In this way, each node obtains benefit metric information from one or more adjacent nodes corresponding to itself, and determines resource allocation corresponding to itself based on the benefit metric information.

Herein, the central node or coordination nodes include, but not limited to, a base station or other transmission points. Here, the term “Base Station (BS)” may be regarded as synonymous to and/or refer to the following terms: base transceiver station(BTS), NodeB, evolved NodeB (eNB), various micro cells, access points, etc, and may be described as a device for providing radio baseband functions for data and/or voice connectivity between the network and one or more users.

The method and apparatus according to the present invention may be used for X2 signaling, but not limited to X2 signaling.

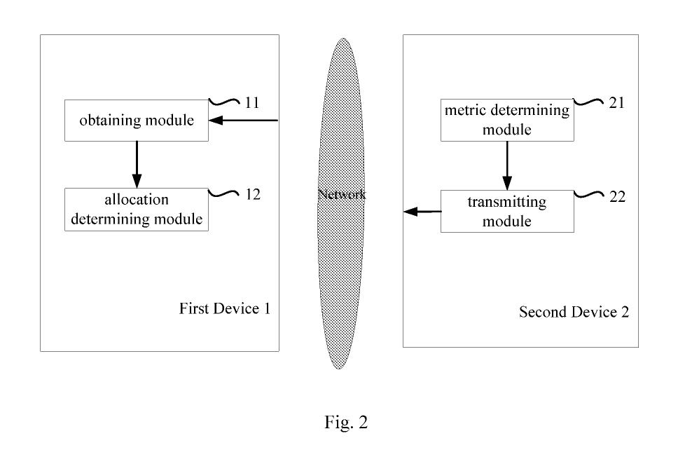

FIG. 2 shows a schematic diagram of a first device and a second device for resource allocation between multiple cells based on coordinated multipoint according to one aspect of the present invention; here, the first device 1 comprises an obtaining module 11, an allocation determining module 12; the second device 2 comprises a metric determining module 21, a transmitting module 22. Specifically, the metric determining module 21 of the second device 2 determines, based on one or more coordinated multipoint simulation scenarios, benefit metric information corresponding to the coordinated multipoint simulation scenario; the transmitting module 22 of the second device 2 transmits the benefit metric information to a first device; correspondingly, the obtaining module 11 of the first device 1 obtains one or more benefit metric information with respect to a second device, wherein the benefit metric information corresponds to one or more coordinated multipoint simulation scenarios; the allocation determining module 12 determines resource allocation information corresponding to an associated device associated with the benefit metric information based on the benefit metric information.

Herein, the first device includes, but not limited to, a central node in a centralized coordinated multipoint system architecture, an arbitrary node in a distributed coordinated multipoint system architecture, and any other device capable having functions of information collection and resource scheduling between multiple cells based on coordinated multipoint. The second device includes, but not limited to, coordination node in the centralized coordinated multipoint system architecture or in distributed coordinated multipoint system architecture, and any other device capable of transmitting benefit metric information and/or information associated with the benefit metric information to the first device.

The metric determining module 21 of the second device 2 determines, based on one or more coordinated multipoint simulation scenarios, benefit metric information corresponding to the coordinated multipoint simulation scenario.

Specifically, the coordinated multipoint simulation scenario includes at least any one of the following:
Coordinated multipoint simulation scenario I: assuming a neighboring node or neighboring cooperation cell is muting to a node or cell corresponding to the second device. For example, as shown in FIG. 1(a), suppose one or more of neighboring nodes eNB 2-eNB 7 are muting to eNB1; wherein the muting indicates that the node or cell lowers resource consumption to reduce power, etc.;
Coordinated multipoint simulation scenario II: assuming the neighboring node or neighboring cooperation cell is muting to a node or cell corresponding to the second device at a preferable time and/or frequency;
Coordinated multipoint simulation scenario III: assuming the neighboring node or neighboring cooperation cell is muting to one or more user equipment (UE) in a node or cell corresponding to the second device.

The term “user equipment” or “UE” used here may be synonymous to a user device, mobile station, mobile user, access terminal, mobile terminal, user, subscriber, radio terminal, terminal, and/or remote station, and may describe a radio resource remote user in a radio communication network. Therefore, the UE may be a radio phone, a laptop equipped with a radio function, and an instrument equipped with a radio function, and the like.

The metric determining module 21 determines, based on a predetermined coordinated multipoint simulation scenario, or based on other manners which could determine the coordinated multipoint simulation scenario, the coordinated multipoint simulation scenario corresponding to the second device 2.

Herein, the manner of determining the coordinated multipoint simulation scenario includes, but not limited to, any one of the following:
a first device 1 associated with the second device 2 has determined the current coordinated multipoint simulation scenario and directly transmits coordinated multipoint simulation scenario notification information or other relevant information capable of hinting the coordinated multipoint simulation scenario information, such that the second device 2 can determine the coordinated multipoint simulation scenario; wherein the first device 1 includes, but not limited to, a central node in a centralized coordinated multipoint system architecture and/or any node in the distributed coordinated multipoint system architecture;
determine the coordinated multipoint simulation scenario corresponding to the second device 2 based on the received other information, such that the second device 2 may independently determine, which is independent of the first device 1, the coordinated multipoint simulation scenario information; for example, if the second device 2 receives benefit metric information transmitted from other device, it may be regarded that the second device 2 can determine the coordinated multipoint simulation scenario. Here, the second device 2 may determine a coordinated multipoint simulation scenario corresponding to the benefit metric information based on the benefit metric information, e.g., the second device 2 is in a muting mode, etc.; besides, the second device 2 may also determine other coordinated multipoint simulation scenario adapted to itself based on the benefit metric information;
the second device 2 autonomously determines a coordinated multipoint simulation scenario.

Then, the metric determining module 21 determines, based on one or more coordinated multipoint simulation scenarios, and based on the manners of determining benefit metric information corresponding to the coordinated multipoint simulation scenario, benefit metric information corresponding to the coordinated multipoint simulation scenario.

Preferably, the benefit metric information includes at least any one of the following:
benefit cell indication information corresponding to the second device;
interference cell indication information corresponding to the second device;
benefit value information corresponding to the benefit cell;
interference level information corresponding to the interference cell;
benefit resource indication information corresponding to the benefit cell;
user information corresponding to the benefit cell;
measurement indication information of channel status information corresponding to the coordinated multipoint simulation scenario.

More preferably, wherein the benefit value information includes at least any one of the following:
percentage information of UL/DL predetermined conserved resources for the benefit cell to all UL/DL available resources;
maximum potential throughput and/or maximum potential performance corresponding to the benefit cell and/or the interference cell;
average potential throughput and/or maximum potential performance corresponding to the benefit cell and/or the interference cell;
potential throughput and/or potential performance of user devices corresponding to the benefit cell and/or the interference cell;
channel information corresponding to the benefit cell, the interference cell, the coordinated multipoint simulation scenario and/or the user device.

Specifically, in coordinated multipoint simulation scenario I:

With FIG. 1(a) as an example, eNB 2 takes itself as a benefit cell; meanwhile, assume an interference cell (or sacrificed cell or damaged cell), e.g., eNB3 or eNB4, is muting and obtain the assumed benefit metric information; eNB 2 reports multiple benefit metric information with labeled cell IDs to the central node, i.e., benefit metric information associated with eNB 3, and benefit metric information associated with eNB 4.

Similarly, the base station 2 will assume a transmission point (TP) muting pattern, i.e., eNB3 and eNB4 are simultaneously muting, and then deriving benefit metric information based on this assumption. eNB 2 will report a single benefit metric information to eNB1 (i.e., central node) with a labeled TP muting pattern, i.e., benefit metric information associated with eNB 3 and eNB 4.

Because the benefit metric information may be cell specific, the benefit metric information may also be a part of a procedure of RNTP (Relative Narrowband TX Power) sharing.

The information of coordinated multipoint simulation scenario corresponding to the coordinated multipoint simulation scenario I may include at least any one of the following information:
BM type: Muting benefit;
Benefit cell to report;
Interfering cell to measurement: Range limitation for considered interfering cell selection, for example threshold setting for interfering cell selection, interfering eNB ID, interfering cell ID and so on;

The benefit metric information corresponding to the coordinated multipoint simulation scenario I may include at least any one of the following information:
BM type: Muting benefit;
Benefit cell to report;
   Report Cell ID
      Interfering cell to measurement
         Interfering Cell ID (i.e. muted cell ID)
         Benefit value

For example, if the report cell ID is cell-1; and the interfering cell ID is cell-2, then the benefit value is the benefit obtained by cell-1 with cell-2 muting.

It should be noted that, here, one benefit value could correspond to one or more interfering cell ID; the information of “interfering cell to measurement” could include interference-level for corresponding interfering cell so that the central node or other decision node could know how to set the transmission power; besides, benefit resource indication information could be included into information of coordinated multipoint simulation scenario and/or benefit metric information, so as to determine the specific resource information need to be muted.

Herein, the benefit value is determined as a percentage of predetermined conserved resources, taking an integer between 0-100; in DL, the numerator in calculation of the percentage is the resource predetermined to be conserved for the benefit cell in the downlink transmission, and the denominator is all available resources on the DL bearer frequency band. Correspondingly, in UL, the numerator in the percentage calculation is the resources predetermined to be conserved for the benefit cell in the uplink transmission, and the denominator is all available resources on the uplink bearer frequency band. Here, the predetermined conserved resources include, but not limited to, limited transmission power on the corresponding interference cell; besides, the resources include, but not limited to, physical resource blocks (PRB). Therefore, if cell 1 reports the benefit value to the corresponding cell 2, then the benefit value reported by cell 1 represents how many resources are limited for conservation on cell 2.

Here, the method of determining the “predetermined protected resource” or “predetermined protected resource block” for an active UE of one node includes, but not limited to, any one of the following:
a sum of traffic buffer areas of all activate UEs, wherein the activate UEs suffer specific interference from one or more specific interference cells;
a sum of expected resources of all activate UEs, wherein the activate UEs suffer specific interference from one or more specific interference cells;
a sum of historical resource usage information of all activate UEs, wherein the activate UEs suffer specific interference from one or more specific interference cells;
the number of all activate UEs, wherein the activate UEs suffer specific interference from one or more specific interference cells.

Table 1 shows a simple example for the information combination above.

Herein, the benefit metric information sent from the second device may include one or more benefit metric information units, i.e., besides at least one of the above information, the benefit metric information may also take multiple items of the above information as one unit, such that the benefit metric information may include one or more benefit metric information units;

One benefit metric information unit could include one benefit cell indication, one benefit value, one benefit resource indication, and one or more interference indications;

One interference indication is associated with one interference cell indication and one interference level.

TABLE 1
Benefit Metric Information from Second Device

| Items | Notes |
|---|---|
| Benefit Metric(BM) Information | Include one or more units. |
| unit item | |
| > BM unit #1 | |
| >> Benefit cell ID | Indicate the benefit cell ID. |
| >> Benefit value | Indicate the benefit value of indicated |
| | benefit cell from indicated one or more |
| | interfering cell(s). |
| >> Benefit resource indication | Indicate considered resource. |
| >> Interference indication item | Include one or more interference |
| | indications. |
| >>> Interference indication #1 | |
| >>>> Interfering cell ID | Indicate the interfering cell ID. |
| >>>> Interference level | Indicate interference level from |
| | corresponding interfering cell. |
| >>> Interference indication #2 | |
| >>>> . . . | |
| > BM unit #2 | |
| >> . . . | |

Here, those skilled in the art should understand, the second device may report the benefit metric information based on periodic trigger, aperiodic trigger, or event trigger; the reporting periodicity for benefit metric information in the coordinated multipoint simulation scenario I may be shorter or longer, e.g., 5 ms, 20 ms, 100 ms, 200 ms, etc.

In coordinated multipoint simulation scenario II:

The information of coordinated multipoint simulation scenario corresponding to the coordinated multipoint simulation scenario II may include at least any one of the following information:
BM type: Muting benefit;
Benefit cell to report;
Interfering cell to measurement: Range limitation for considered interfering cell selection, for example threshold setting for interfering cell selection, interfering eNB ID, interfering cell ID and so on;
Channel State Information (CSI) to measurement: Limitation for considered CSI information for throughput benefit calculation. For example indication by CSI process.

The benefit metric information corresponding to the coordinated multipoint simulation scenario II may include at least any one of the following information:
BM type: Muting benefit;
Benefit cell to report
   Report Cell ID
      Frequency index
         CSI indication list, and/or
         CSI indication index (for example CSI process index)
         Benefit value
         Point muting list
         Interfering Cell ID (i.e. muted cell ID)
         Benefit value

It should be noted that:

One benefit value could correspond to one CSI indication index (for example one CSI process index);

One benefit value could correspond to one or more interfering cell ID;

The information of “interfering cell to measurement” could include interference-level for corresponding interfering cell so that the central node could know how to set the transmission power;

Benefit resource indication could be included into the coordinated multipoint simulation scenario and/or benefit metric information;

Considered frequency index for resource indication could be extended to time domain;

Considered frequency index for resource indication could be extended to time frequency domain;

The “CS I to measurement” could be treated as “Throughput to measurement”, or other similar definition.

Here, the benefit value may be determined a maximum potential throughput and/or maximum potential performance corresponding to the benefit cell and/or the interference cell, or determines as an average potential throughput and/or maximum potential performance corresponding to the benefit cell and/or the interference cell; the maximum potential throughput and/or maximum potential performance, the average potential throughput and/or maximum potential performance may be determined based on proportional fair (PF).

Here, those skilled in the art should understand, the second device may report the benefit metric information based on periodic trigger, aperiodic trigger, or event trigger; the reporting periodicity for benefit metric information in the coordinated multipoint simulation scenario II may be shorter or longer, e.g., 2 ms, 5 ms, 20 ms, 100 ms, 200 ms, etc.

Here, those skilled in the art should understand, other method or flow of the second device in the coordinated multipoint simulation scenario II is identical or similar to the flow in the coordinated multipoint simulation scenario I. Therefore, it will not be detailed here but is incorporated here by reference.

In coordinated multipoint simulation scenario III:

The information of coordinated multipoint simulation scenario corresponding to the coordinated multipoint simulation scenario III may include at least any one of the following information:
BM type: Muting benefit;
Benefit cell to report;
Benefit UE to report;
Interfering cell to measurement: Range limitation for considered interfering cell selection, for example threshold setting for interfering cell selection, interfering eNB ID, interfering cell ID and so on;
Channel State Information (CSI) to measurement: Limitation for considered CSI information for throughput benefit calculation. For example indication by CSI process.

The benefit metric information corresponding to the coordinated multipoint simulation scenario III may include at least any one of the following information:
BM type: Muting benefit;
Benefit cell to report
   Report Cell ID
      Report UE ID
         Frequency index
         CSI indication list, and/or
         CSI indication index (for example CSI process index)
         Benefit value
         Point muting list
         Interfering Cell ID (i.e. muted cell ID)
         Benefit value
The user information corresponding to the benefit cell;
Indication information for CSI to measurement corresponding to the coordinated multipoint simulation scenario.

It should be noted that:

One benefit value could correspond to one CSI indication index (for example one CSI process index);

One benefit value could correspond to one or more interfering cell ID;

The information of “interfering cell to measurement” could include interference-level for corresponding interfering cell so that the central node could know how to set the transmission power;

Benefit resource indication could be included into the coordinated multipoint simulation scenario and/or benefit metric information;

Considered frequency index for resource indication could be extended to time domain;

Considered frequency index for resource indication could be extended to time frequency domain;

The “CSI to measurement” could be treated as “Throughput to measurement”, or other similar definition;

The benefit value could be replaced by CQI (Channel Quality Indicator), PMI (Precoding Matrix Indicator) RI (Rank Indication) and/or RSRP (Reference Signal Receiving Power) too;

If the benefit value is CQI, then the CQI could be the value with the consideration of PF factor.

Herein, the benefit value may be determined as a potential throughput and/or potential performance of the user equipment corresponding to the benefit cell and/or the interference cell. The potential throughput and/or potential performance may be determined based on proportional fair (PF); besides, the benefit value may also be determined as channel information corresponding to the benefit cell, the interference cell, the coordinated multipoint simulation scenario and/or the user equipment.

Here, those skilled in the art should understand, the second device may report the benefit metric information based on periodic trigger, aperiodic trigger, or event trigger; the reporting periodicity for benefit metric information in the coordinated multipoint simulation scenario III may be shorter or longer, e.g., 2 ms, 5 ms, 20 ms, 100 ms, 200 ms, etc.

Here, those skilled in the art should understand, other flow of the second device in the coordinated multipoint simulation scenario III is identical or similar to the flow in the coordinated multipoint simulation scenario I or II. Therefore, it will not be detailed here but is incorporated here by reference.

The transmitting module 22 of the second device 2 transmits the benefit metric information to a first device.

Specifically, the transmitting module 22 transmits the benefit metric information in a certain information format (e.g., as shown in Table 1) to the first device 1 based on a predetermined communication protocol.

Preferably, CSI or RSRP may be transmitted to the first device as benefit metric information.

Preferably, the transmitting module 22 may transmit the benefit metric information to the first device based on periodic, aperiodic or event trigger.

In the case of transmitting periodically, the determined transmitting period (i.e., reporting periodicity) may be determined dependent on different coordinated multipoint simulation scenarios; i.e., in the coordinated multipoint simulation scenario I, the reporting periodicity may be shorter or longer, e.g., 5 ms, 20 ms, 100 ms, 200 ms, etc.; in coordinated multipoint simulation scenario II, the reporting periodicity may be shorter or longer, e.g., 2 ms, 5 ms, 20 ms, 100 ms, 200 ms, etc.; in coordinated multipoint simulation scenario III, the reporting periodicity may be shorter or longer, e.g., 2 ms, 5 ms, 20 ms, 100 ms, 200 ms, etc.

Correspondingly, the obtaining module 11 of the first device 1 obtains one or more benefit metric information with respect to a second device, wherein the benefit metric information corresponds to one or more coordinated multipoint simulation scenarios.

Specifically, the obtaining module 11 interacts with the second device 2 based on a predetermined communication protocol, or interacts with a device capable of providing benefit metric information about the second device, so as to obtain one or more pieces of benefit metric information about the second device. The obtained benefit metric information may be benefit metric information determined based on the same coordinated multipoint simulation scenario or the benefit metric information determined based on different coordinated multipoint simulation scenarios. Besides, the second device corresponding to the obtained benefit metric information may be one second device or more second devices.

The allocation determining module 12 determines resource allocation information corresponding to an associated device associated with the benefit metric information based on the benefit metric information.

Specifically, the allocation determining module 12 determines resource allocation information corresponding to an associated device for the benefit metric information after making judgments on the devices and benefit values corresponding to different benefit metric information according to one or more benefit metric information.

Wherein, the associated device includes, but not limited to, the first device or the second device, or other coordinated transmission point. For example, in the centralized coordinated multipoint architecture, the first device obtains benefit metric information transmitted from one or more second devices, and determines resource allocation information corresponding to the one or more second devices; in the distributed coordinated multipoint architecture, the first device obtains benefit metric information transmitted from one or more second devices (i.e., coordination node), and determines the resource allocation information corresponding to itself (i.e., the first device).

Preferably, further, the associated device performs resource scheduling and allocation based on the resource allocation information.

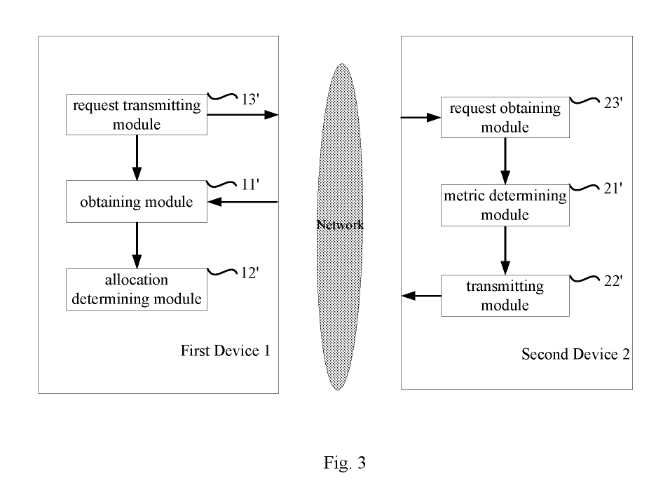

FIG. 3 shows a schematic diagram of a first device and a second device for resource allocation between multiple cells based on coordinated multipoint according to a preferred embodiment of the present invention; here, the first device 1 comprises an obtaining module 11′, an allocation determining module 12′, a request transmitting module 13′; the second device 2 comprises a metric determining module 21′, a transmitting module 22′, a request obtaining module 23′. Specifically, the request transmitting module 13′ of the first device 1 transmits benefit metric request information to one or more second devices; correspondingly, the request obtaining module 23′ of the second device 2 obtains benefit metric request information transmitted by the first device; the metric determining module 21′ of the second device 2 determines, based on the benefit metric request information and in conjunction with one or more coordinated multipoint simulation scenarios, benefit metric information corresponding to the coordinated multipoint simulation scenarios; the transmitting module 22′ of the second device 2 transmits the benefit metric information to a first device; correspondingly, the obtaining module 11′ of the first device 1 obtains benefit metric information transmitted by the second device based on the benefit metric request information, wherein the benefit metric information corresponds to one or more coordinated multipoint simulation scenarios; the allocation determining module 12′ determines resource allocation information corresponding to an associated device associated with the benefit metric information based on the benefit metric information.

Herein, the allocation determining module 12′ of the first device 1 and the transmitting module 22′ of the second device 2 are identical or substantially identical to corresponding apparatus shown in FIG. 2, which are thus not detailed here, but incorporated here by reference.

The request transmitting module 13′ transmits benefit metric request information to one or more second devices.

Specifically, the request transmitting module 13′ transmits the benefit metric request information to one or more second devices based on a predetermined communication protocol; wherein the benefit metric request information may include coordinated multipoint simulation scenario information for determining benefit metric information.

Correspondingly, the request obtaining module 23′ of the second device 2 obtains benefit metric request information transmitted by the first device.

Specifically, the request obtaining module 23′ obtains the benefit metric request information transmitted from the first device based on a predetermined communication protocol.

Herein, those skilled in the art should understand, in the centralized coordinated multipoint architecture, the benefit metric request information may be transmitted by the request transmitting module 13′ to the second device, such that the second device determines the corresponding benefit metric information or CSI/RSRP information equivalent to the benefit metric information based on relevant configurations in the benefit metric request information, and transmits it to the first device. In the distributed coordinated multipoint architecture, the second device may directly determine the corresponding benefit metric information or CSI/RSRP information equivalent to the benefit metric information based on presumed or inferred coordinated multipoint simulation scenario (e.g., assume that the target base station (i.e., the first device 1) is muted), and transmit it to the first device, without a need of obtaining the benefit metric request information. For the same rationale, in the centralized coordinated multipoint architecture, the corresponding benefit metric information or CSI/RSRP information equivalent to the benefit metric information may also be directly determined by the second device without being based on the benefit metric request information and transmit to the first device.

Herein, the benefit metric information may include at least any one of the following information:
Message Type: BM request
Initiating eNB ID: INTEGER (1 . . . 4095, . . . ), for example the eNB ID of Node 1
Measurement eNB ID: INTEGER (1 . . . 4095, . . . ), for example the eNB ID of Node 2
Registration Request: ENUMERATED (start, stop, . . . ): A value set to “start”, indicates a request to start corresponding measurement report. A value set to “stop”, indicates a request to stop corresponding measurement report.
Cell To Report: Indicate the cell(s) for measurement report, for example one or more cell ID for corresponding measurement report.
Cell To Measurement: Indicate the interfering cell(s) for benefit measurement, for example one or more cell ID(s) for considered benefit measurement.
Reporting Periodicity: ENUMERATED, for example 5 ms, 10 ms, 20 ms, 100 ms, 1000 ms, 2000 ms, 5000 ms, 10000 ms and so on.
Partial Success Indicator: NUMERATED (partial success allowed, . . . ), Included if partial success is allowed.

It should be noted that: besides the solution above, the “Cell To Measurement” also could be RSRP threshold. For example if the RSRP reported by a UE and corresponding to a cell is no threshold less than its serving cell, then the cell is considered as interfering cell for benefit measurement.

Preferably, the benefit metric request information may also be enhanced to the resource status request information in the resource status report information employed by the current X2, so as to transmit it to the request obtaining module 23′ through the request transmitting module 13′.

Here, the enhancement to the resource status request information may be implemented by adding extra one or more bits in the current resource status request information, e.g., the Sixth Bit corresponding to the periodicity of the benefit metric information and/or the seventh bit corresponding to the event trigger of the benefit metric information.

The resource status request information may include, but not limited to, at least any one of the following information:
Cell To Measurement: indicate the interfering cell(s) for benefit measurement, for example one or more cell ID(s) for considered benefit measurement; here, a “measurement base station ID1” may be regarded as an “Initiating eNB ID”;
Initiating eNB ID: INTEGER (1 . . . 4095, . . . ), for example the eNB ID of Node 1; here, the functions of “measurement base station ID1” is the same as the ones of the defined “Cell To Measurement” above;
Reporting Periodicity: ENUMERATED, such as lms, 2 ms, 5 ms, 10 ms, 20 ms, 100 ms, 1000 ms, 2000 ms, 10000 ms, etc.

If the resource status request information not only includes “Initiating eNB ID,” but also includes “Cell To Measurement”; then the base station in charge of reception may also report the metric measurement report to the “Initiating eNB ID.”

The metric determining module 21′ of the second device 2 determines, based on the benefit metric request information and in conjunction with one or more coordinated multipoint simulation scenarios, benefit metric information corresponding to the coordinated multipoint simulation scenarios.

Specifically, the metric determining module 21′ determines benefit metric information corresponding to the coordinated multipoint simulation scenario based on parameters in the benefit metric request information in conjunction with a coordinated multipoint simulation scenario determined based on the benefit metric request information or a coordinated multipoint simulation scenario determined based on other manners.

For example, if a registration request in the benefit metric request information is set to “start,” then the metric determining module 21′ determines benefit metric information corresponding to the coordinated multipoint simulation scenario in conjunction with a coordinated multipoint simulation scenario determined based on the benefit metric request information or a coordinated multipoint simulation scenario determined based on other manners.

For another example, if the registration request in the benefit metric request information is set to “stop,” then the metric determining module 21′ stops measurement and transmission of the benefit metric information.

The obtaining module 11′ of the first device 1 obtains benefit metric information transmitted by the second device based on the benefit metric request information, wherein the benefit metric information corresponds to one or more coordinated multipoint simulation scenarios.

Specifically, the obtaining module 11′ interacts with the second device 2 based on the benefit metric request information according to the predetermined communication protocol, or interacts with other device capable of providing benefit metric information about the second device to obtain one or more benefit metric information of the second device.

Herein, the benefit metric information includes, but not limited to, at least any one of the following information:
Message Type: benefit metric request information or benefit metric update information(BM update)
Initiating eNB ID: INTEGER (1 . . . 4095, . . . ), for example the eNB ID of Node 1
Measurement eNB ID: INTEGER (1 . . . 4095, . . . ), for example the eNB ID of Node 2
BM Result: i.e., corresponding to various benefit metric information shown in FIG. 1.

Preferably, the obtaining module 11′ could obtain, based on resource status report information corresponding to one or more second devices, benefit metric information transmitted by the second device, wherein the benefit metric information corresponds to one or more coordinated multipoint simulation scenarios.

Specifically, the obtaining module 11′ may obtain the benefit metric information transmitted by the second device through enhancing the resource status update information in the resource status report information employed by the current X2.

Here, the resource status update information may be enhanced by adding extra one or more bits in the current resource status update information, for example, the Sixth Bit corresponding to the periodicity of the benefit metric information and/or the seventh bit corresponding to the event trigger of the benefit metric information.

Herein, the item of the result of the cell to measurement in the resource status update information may include benefit metric information. The benefit metric information may be determined according to the benefit metric information defined in FIG. 1.

Without the indication of the “Initiating eNB ID”, the resource status update information may use the “Measurement eNB ID1” as the “Initiating eNB ID” or including the “Initiating eNB ID” information. In the latter case, the “Measurement eNB ID1” is functionally consistent with the “Cell to Measurement” as defined above.

Preferably, the metric determining module 21′ could transmit, based on the benefit metric request information and in conjunction with one or more coordinated multipoint simulation scenarios, benefit metric response information corresponding to the benefit metric request information to a first device; and then transmit, based on the benefit metric response information, benefit metric information corresponding to the benefit metric response information to the first device, wherein the benefit metric information corresponds to one or more coordinated multipoint simulation scenarios.

Correspondingly, the obtaining module 11′ could obtain benefit metric response information corresponding to the benefit metric request information according to the benefit metric request information; and then obtain benefit metric information transmitted by the second device based on the benefit metric response information, wherein the benefit metric information corresponds to one or more coordinated multipoint simulation scenarios.

Specifically, the benefit metric response information is for reporting that one or more reported targets have been successfully initialized.

Herein, the benefit metric response information includes, but not limited to, at least any one of the following information:
Message Type: BM Response
Initiating eNB ID: for example the eNB ID of Node 1
Measurement eNB ID: for example the eNB ID of Node 2
Measurement Initiation Result: Indicate which cell could be configured to report or not.

Preferably, the benefit metric response information may also be enhanced to resource status response information in the resource status report information employed in the current X2, so as to perform information transmission between the first device 1 and the second device 2.

Here, the resource status response information may be enhanced by adding extra one or more bits in the current resource status response information, e.g., the

Sixth Bit corresponding to the periodicity of the benefit metric information and/or the seventh bit corresponding to the event trigger of the benefit metric information.

Herein, without the indication information for the “Initiating eNB ID”, the resource status response information may use the “Measurement eNB ID1” as the “Initiating eNB ID” or including the “Initiating eNB ID” information. In the latter case, the “Measurement eNB ID1” is functionally consistent with the “Cell to Measurement” as defined above.

Here, those skilled in the art should understand, the above benefit metric response information and/or resource status response information are all explanations in the case of successfully responding to the benefit metric request information and/or resource status request information; in case of failed response to the benefit metric request information and/or resource status request information, then the benefit metric response information and/or resource status response information may also be benefit metric failure information and/or resource status failure information.

Herein, the benefit metric failure information indicates that for none of the requested measurement objects the measurement can be initiated, the benefit metric failure information includes, but not limited to, at least any one of the following information:
Message Type: BM failure
Initiating eNB ID: INTEGER (1 . . . 4095, . . . ), for example the eNB ID of Node 1
Measurement eNB ID: INTEGER (1 . . . 4095, . . . ), for example the eNB ID of Node 2
Failure Cause: indicate the failure cause

Preferably, the benefit metric failure information may also be enhanced to resource status failure information in the resource status report information employed by the current X2, so as to perform information transmission between the first device 1 and the second device 2.

Here, the resource status failure information may be enhanced through for example adding extra one or more bits in the current resource status failure information, e.g., the Sixth Bit corresponding to the periodicity of the benefit metric information and/or the seventh bit corresponding to the event trigger of the benefit metric information.

Herein, without the indication information of the “Initiating eNB ID,” the resource status failure information may use the “Measurement eNB ID1” as the “Initiating eNB ID” or including the “Initiating eNB ID” information. In the latter case, the “Measurement eNB ID1” is functionally consistent with the “Cell to Measurement” as defined above.

For example, if cell 1 has obtained benefits through muting cell 2 and cell 3, then cell 1 is “Initiating eNB,” cell 2 is “Cell to Measurement,” and cell 1 is “Reporting cell”.

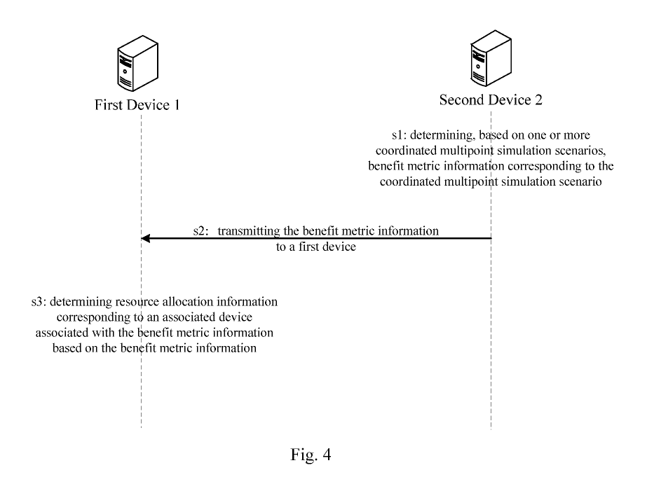

FIG. 4 shows a flow diagram of a method for resource allocation between multiple cells based on coordinated multipoint by cooperation of a first device and a second device according to another aspect of the present invention. Specifically, in the step s1, the second device 2 determines, based on one or more coordinated multipoint simulation scenarios, benefit metric information corresponding to the coordinated multipoint simulation scenario; in the step s2, the second device 2 transmits the benefit metric information to a first device; correspondingly, in the step s2, the first device 1 obtains one or more benefit metric information with respect to a second device, wherein the benefit metric information corresponds to one or more coordinated multipoint simulation scenarios; in the step s3, the first device 1 determines resource allocation information corresponding to an associated device associated with the benefit metric information based on the benefit metric information.

In the step s1, the second device 2 determines, based on one or more coordinated multipoint simulation scenarios, benefit metric information corresponding to the coordinated multipoint simulation scenario.

Specifically, the coordinated multipoint simulation scenario includes at least any one of the following:
Coordinated multipoint simulation scenario I: assuming a neighboring node or neighboring cooperation cell is muting to a node or cell corresponding to the second device. For example, as shown in FIG. 1(a), suppose one or more of neighboring nodes eNB 2-eNB 7 are muting to eNB 1; wherein the muting indicates that the node or cell lowers resource consumption to reduce power, etc.;
Coordinated multipoint simulation scenario II: assuming the neighboring node or neighboring cooperation cell is muting to a node or cell corresponding to the second device at a preferable time and/or frequency;
Coordinated multipoint simulation scenario III: assuming the neighboring node or neighboring cooperation cell is muting to one or more user equipment (UE) in a node or cell corresponding to the second device.

In the step s1, the second device 2 determines, based on a predetermined coordinated multipoint simulation scenario, or based on other manners which could determine the coordinated multipoint simulation scenario, the coordinated multipoint simulation scenario corresponding to the second device 2.

Herein, the manner of determining the coordinated multipoint simulation scenario includes, but not limited to, any one of the following:
a first device 1 associated with the second device 2 has determined the current coordinated multipoint simulation scenario and directly transmits coordinated multipoint simulation scenario notification information or other relevant information capable of hinting the coordinated multipoint simulation scenario information, such that the second device 2 can determine the coordinated multipoint simulation scenario; wherein the first device 1 includes, but not limited to, a central node in a centralized coordinated multipoint system architecture and/or any node in the distributed coordinated multipoint system architecture;
determine the coordinated multipoint simulation scenario corresponding to the second device 2 based on the received other information, such that the second device 2 may independently determine, which is independent of the first device 1, the coordinated multipoint simulation scenario information; for example, if the second device 2 receives benefit metric information transmitted from other device, it may be regarded that the second device 2 can determine the coordinated multipoint simulation scenario. Here, the second device 2 may determine a coordinated multipoint simulation scenario corresponding to the benefit metric information based on the benefit metric information, e.g., the second device 2 is in a muting mode, etc.; besides, the second device 2 may also determine other coordinated multipoint simulation scenario adapted to itself based on the benefit metric information;
the second device 2 autonomously determines a coordinated multipoint simulation scenario.

Then, in the step s1, the second device 2 determines, based on one or more coordinated multipoint simulation scenarios, and based on the manners of determining benefit metric information corresponding to the coordinated multipoint simulation scenario, benefit metric information corresponding to the coordinated multipoint simulation scenario.

Preferably, the benefit metric information includes at least any one of the following:
benefit cell indication information corresponding to the second device;
interference cell indication information corresponding to the second device;
benefit value information corresponding to the benefit cell;
interference level information corresponding to the interference cell;
benefit resource indication information corresponding to the benefit cell;
user information corresponding to the benefit cell;
measurement indication information of channel status information corresponding to the coordinated multipoint simulation scenario..

More preferably, wherein the benefit value information includes at least any one of the following:
percentage information of UL/DL predetermined conserved resources for the benefit cell to all UL/DL available resources;
maximum potential throughput and/or maximum potential performance corresponding to the benefit cell and/or the interference cell;
average potential throughput and/or maximum potential performance corresponding to the benefit cell and/or the interference cell;
potential throughput and/or potential performance of user devices corresponding to the benefit cell and/or the interference cell;
channel information corresponding to the benefit cell, the interference cell, the coordinated multipoint simulation scenario and/or the user device.

Specifically, in coordinated multipoint simulation scenario I:

With FIG. 1(a) as an example, eNB 2 takes itself as a benefit cell; meanwhile, assume an interference cell (or sacrificed cell or damaged cell), e.g., eNB3 or eNB4, is muting and obtain the assumed benefit metric information; eNB 2 reports multiple benefit metric information with labeled cell IDs to the central node, i.e., benefit metric information associated with eNB 3, and benefit metric information associated with eNB 4.

Similarly, the base station 2 will assume a transmission point (TP) muting pattern, i.e., eNB3 and eNB4 are simultaneously muting, and then deriving benefit metric information based on this assumption. eNB 2 will report a single benefit metric information to eNB1 (i.e., central node) with a labled TP muting pattern, i.e., benefit metric information associated with eNB 3 and eNB 4.

Because the benefit metric information may be cell specific, the benefit metric information may also be a part of a procedure of RNTP (Relative Narrowband TX Power) sharing.

The information of coordinated multipoint simulation scenario corresponding to the coordinated multipoint simulation scenario I may include at least any one of the following information:
BM type: Muting benefit;
Benefit cell to report;
Interfering cell to measurement: Range limitation for considered interfering cell selection, for example threshold setting for interfering cell selection, interfering eNB ID, interfering cell ID and so on;

The benefit metric information corresponding to the coordinated multipoint simulation scenario I may include at least any one of the following information:
BM type: Muting benefit;
Benefit cell to report;
   Report Cell ID
      Interfering cell to measurement
         Interfering Cell ID (i.e. muted cell ID)
         Benefit value

For example, if the report cell ID is cell-1 and the interfering cell ID is cell-2, then the benefit value is the benefit obtained by cell-1 with cell-2 muting.

It should be noted that, here, one benefit value could correspond to one or more interfering cell ID; the information of “interfering cell to measurement” could include interference-level for corresponding interfering cell so that the central node or other decision node could know how to set the transmission power; besides, benefit resource indication information could be included into information of coordinated multipoint simulation scenario and/or benefit metric information, so as to determine the specific resource information need to be muted.

Herein, the benefit value is determined as a percentage of predetermined conserved resources, taking an integer between 0-100; in DL, the numerator in calculation of the percentage is the resource predetermined to be conserved for the benefit cell in the downlink transmission, and the denominator is all available resources on the DL bearer frequency band. Correspondingly, in UL, the numerator in the percentage calculation is the resources predetermined to be conserved for the benefit cell in the uplink transmission, and the denominator is all available resources on the uplink bearer frequency band. Here, the predetermined conserved resources include, but not limited to, limited transmission power on the corresponding interference cell; besides, the resources include, but not limited to, physical resource blocks (PRB). Therefore, if cell 1 reports the benefit value to the corresponding cell 2, then the benefit value reported by cell 1 represents how many resources are limited for conservation on cell 2.

Here, the method of determining the “predetermined protected resource” or “predetermined protected resource block” for an active UE of one node includes, but not limited to, any one of the following:
a sum of traffic buffer areas of all activate UEs, wherein the activate UEs suffer specific interference from one or more specific interference cells;
a sum of expected resources of all activate UEs, wherein the activate UEs suffer specific interference from one or more specific interference cells;
a sum of historical resource usage information of all activate UEs, wherein the activate UEs suffer specific interference from one or more specific interference cells;
the number of all activate UEs, wherein the activate UEs suffer specific interference from one or more specific interference cells.

Table 2 shows a simple example for the information combination above.

Herein, the benefit metric information sent from the second device may include one or more benefit metric information units, i.e., besides at least one of the above information, the benefit metric information may also take multiple items of the above information as one unit, such that the benefit metric information may include one or more benefit metric information units;

One benefit metric information unit could include one benefit cell indication, one benefit value, one benefit resource indication, and one or more interference indications;

One interference indication is associated with one interference cell indication and one interference level.

TABLE 2
Benefit Metric Information from Second Device

| Items | Notes |
|---|---|
| Benefit Metric(BM) Information | Include one or more units. |
| unit item | |
| > BM unit #1 | |
| >> Benefit cell ID | Indicate the benefit cell ID. |
| >> Benefit value | Indicate the benefit value of indicated |
| | benefit cell from indicated one or more |
| | interfering cell(s). |
| >> Benefit resource indication | Indicate considered resource. |
| >> Interference indication item | Include one or more interference |
| | indications. |
| >>> Interference indication #1 | |
| >>>> Interfering cell ID | Indicate the interfering cell ID. |
| >>>> Interference level | Indicate interference level from |
| | corresponding interfering cell. |
| >>> Interference indication #2 | |
| >>>> . . . | |
| > BM unit #2 | |
| >> . . . | |

Here, those skilled in the art should understand, the second device may report the benefit metric information based on periodic trigger, aperiodic trigger, or event trigger; the reporting periodicity for benefit metric information in the coordinated multipoint simulation scenario I may be shorter or longer, e.g., 5 ms, 20 ms, 100 ms, 200 ms, etc.

In coordinated multipoint simulation scenario II:

The information of coordinated multipoint simulation scenario corresponding to the coordinated multipoint simulation scenario II may include at least any one of the following information:
BM type: Muting benefit;
Benefit cell to report;
Interfering cell to measurement: Range limitation for considered interfering cell selection, for example threshold setting for interfering cell selection, interfering eNB ID, interfering cell ID and so on;
Channel State Information (CSI) to measurement: Limitation for considered CSI information for throughput benefit calculation. For example indication by CSI process.

The benefit metric information corresponding to the coordinated multipoint simulation scenario II may include at least any one of the following information:
BM type: Muting benefit;
Benefit cell to report
   Report Cell ID
      Frequency index
         CSI indication list, and/or
         CSI indication index (for example CSI process index)
         Benefit value
         Point muting list
         Interfering Cell ID (i.e. muted cell ID)
         Benefit value

It should be noted that:

One benefit value could correspond to one CSI indication index (for example one CSI process index);

One benefit value could correspond to one or more interfering cell ID;

The information of “interfering cell to measurement” could include interference-level for corresponding interfering cell so that the central node could know how to set the transmission power;

Benefit resource indication could be included into the coordinated multipoint simulation scenario and/or benefit metric information;

Considered frequency index for resource indication could be extended to time domain;

Considered frequency index for resource indication could be extended to time frequency domain;

The “CSI to measurement” could be treated as “Throughput to measurement”, or other similar definition.

Here, the benefit value may be determined a maximum potential throughput and/or maximum potential performance corresponding to the benefit cell and/or the interference cell, or determines as an average potential throughput and/or maximum potential performance corresponding to the benefit cell and/or the interference cell; the maximum potential throughput and/or maximum potential performance, the average potential throughput and/or maximum potential performance may be determined based on proportional fair (PF).

Here, those skilled in the art should understand, the second device may report the benefit metric information based on periodic trigger, aperiodic trigger, or event trigger; the reporting periodicity for benefit metric information in the coordinated multipoint simulation scenario II may be shorter or longer, e.g., 2 ms, 5 ms, 20 ms, 100 ms, 200 ms, etc.

Here, those skilled in the art should understand, other method or flow of the second device in the coordinated multipoint simulation scenario II is identical or similar to the flow in the coordinated multipoint simulation scenario I. Therefore, it will not be detailed here but is incorporated here by reference.

In coordinated multipoint simulation scenario III:

The information of coordinated multipoint simulation scenario corresponding to the coordinated multipoint simulation scenario III may include at least any one of the following information:
BM type: Muting benefit;
Benefit cell to report;
Benefit UE to report;
Interfering cell to measurement: Range limitation for considered interfering cell selection, for example threshold setting for interfering cell selection, interfering eNB ID, interfering cell ID and so on;
Channel State Information (CSI) to measurement: Limitation for considered CSI information for throughput benefit calculation. For example indication by CSI process.

The benefit metric information corresponding to the coordinated multipoint simulation scenario III may include at least any one of the following information:
BM type: Muting benefit;
Benefit cell to report
   Report Cell ID
      Report UE ID
         Frequency index
         CSI indication list, and/or
         CSI indication index (for example CSI process index)
         Benefit value
         Point muting list
         Interfering Cell ID (i.e. muted cell ID)
         Benefit value
The user information corresponding to the benefit cell;
Indication information for CSI to measurement corresponding to the coordinated multipoint simulation scenario.

It should be noted that:

One benefit value could correspond to one CSI indication index (for example one CSI process index);

One benefit value could correspond to one or more interfering cell ID;

The information of “interfering cell to measurement” could include interference-level for corresponding interfering cell so that the central node could know how to set the transmission power;

Benefit resource indication could be included into the coordinated multipoint simulation scenario and/or benefit metric information;

Considered frequency index for resource indication could be extended to time domain;

Considered frequency index for resource indication could be extended to time frequency domain;

The “CSI to measurement” could be treated as “Throughput to measurement”, or other similar definition;

The benefit value could be replaced by CQI (Channel Quality Indicator), PMI (Precoding Matrix Indicator) RI (Rank Indication) and/or RSRP (Reference Signal Receiving Power) too;

If the benefit value is CQI, then the CQI could be the value with the consideration of PF factor.

Herein, the benefit value may be determined as a potential throughput and/or potential performance of the user equipment corresponding to the benefit cell and/or the interference cell. The potential throughput and/or potential performance may be determined based on proportional fair (PF); besides, the benefit value may also be determined as channel information corresponding to the benefit cell, the interference cell, the coordinated multipoint simulation scenario and/or the user equipment.

Here, those skilled in the art should understand, the second device may report the benefit metric information based on periodic trigger, aperiodic trigger, or event trigger; the reporting periodicity for benefit metric information in the coordinated multipoint simulation scenario III may be shorter or longer, e.g., 2 ms, 5 ms, 20 ms, 100 ms, 200 ms, etc.

Here, those skilled in the art should understand, other flow of the second device in the coordinated multipoint simulation scenario III is identical or similar to the flow in the coordinated multipoint simulation scenario I or II. Therefore, it will not be detailed here but is incorporated here by reference.

In the step s2, the second device 2 transmits the benefit metric information to a first device.

Specifically, in the step s2, the second device 2 transmits the benefit metric information in a certain information format (e.g., as shown in Table 1) to the first device 1 based on a predetermined communication protocol.

Preferably, CSI or RSRP may be transmitted to the first device as benefit metric information.

Preferably, in the step s2, the second device 2 may transmit the benefit metric information to the first device based on periodic, aperiodic or event trigger.

In the case of transmitting periodically, the determined transmitting period (i.e., reporting periodicity) may be determined dependent on different coordinated multipoint simulation scenarios; i.e., in the coordinated multipoint simulation scenario I, the reporting periodicity may be shorter or longer, e.g., 5 ms, 20 ms, 100 ms, 200 ms, etc.; in coordinated multipoint simulation scenario II, the reporting periodicity may be shorter or longer, e.g., 2 ms, 5 ms, 20 ms, 100 ms, 200 ms, etc.; in coordinated multipoint simulation scenario III, the reporting periodicity may be shorter or longer, e.g., 2 ms, 5 ms, 20 ms, 100 ms, 200 ms, etc.

Correspondingly, in the step s2, the first device 1 obtains one or more benefit metric information with respect to a second device, wherein the benefit metric information corresponds to one or more coordinated multipoint simulation scenarios.

Specifically, in the step s2, the first device 1 interacts with the second device 2 based on a predetermined communication protocol, or interacts with a device capable of providing benefit metric information about the second device, so as to obtain one or more pieces of benefit metric information about the second device. The obtained benefit metric information may be benefit metric information determined based on the same coordinated multipoint simulation scenario or the benefit metric information determined based on different coordinated multipoint simulation scenarios. Besides, the second device corresponding to the obtained benefit metric information may be one second device or more second devices.

In the step s3, the first device 1 determines resource allocation information corresponding to an associated device associated with the benefit metric information based on the benefit metric information.

Specifically, in the step s2, the first device 1 determines resource allocation information corresponding to an associated device for the benefit metric information after making judgments on the devices and benefit values corresponding to different benefit metric information according to one or more benefit metric information.

Wherein, the associated device includes, but not limited to, the first device or the second device, or other coordinated transmission point. For example, in the centralized coordinated multipoint architecture, the first device obtains benefit metric information transmitted from one or more second devices, and determines resource allocation information corresponding to the one or more second devices; in the distributed coordinated multipoint architecture, the first device obtains benefit metric information transmitted from one or more second devices (i.e., coordination node), and determines the resource allocation information corresponding to itself (i.e., the first device).

Preferably, further, the associated device performs resource scheduling and allocation based on the resource allocation information.

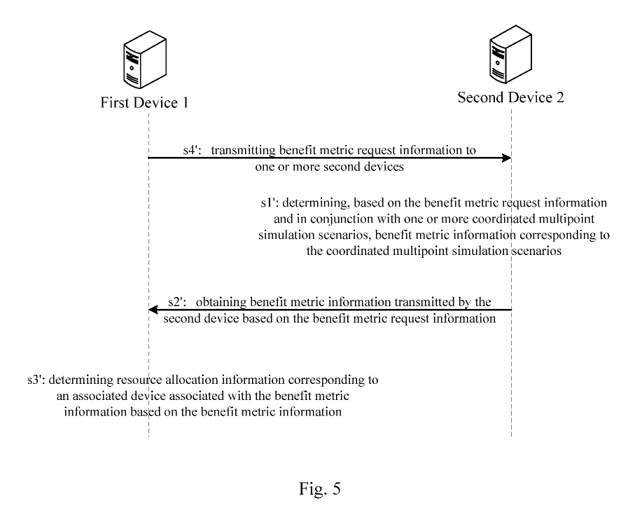

FIG. 5 shows a flow diagram of a method for resource allocation between multiple cells based on coordinated multipoint by cooperation of a first device and a second device according to a preferred embodiment of the present invention.

Specifically, in the step s4′, the first device 1 transmits benefit metric request information to one or more second devices; correspondingly, in the step s4′, the second device 2 obtains benefit metric request information transmitted by the first device; in the step s1′, the second device 2 determines, based on the benefit metric request information and in conjunction with one or more coordinated multipoint simulation scenarios, benefit metric information corresponding to the coordinated multipoint simulation scenarios; in the step s2′, the second device 2 transmits the benefit metric information to a first device; correspondingly, in the step s2′, the first device 1 obtains benefit metric information transmitted by the second device based on the benefit metric request information, wherein the benefit metric information corresponds to one or more coordinated multipoint simulation scenarios; in the step s3′, the first device 1 determines resource allocation information corresponding to an associated device associated with the benefit metric information based on the benefit metric information.

Herein, the step s3′ of the first device 1 and the step s2′ of the second device 2 are identical or substantially identical to corresponding apparatus shown in FIG. 4, which are thus not detailed here, but incorporated here by reference.

In the step s4′, the first device 1 transmits benefit metric request information to one or more second devices.

Specifically, in the step s4′, the first device 1 transmits the benefit metric request information to one or more second devices based on a predetermined communication protocol; wherein the benefit metric request information may include coordinated multipoint simulation scenario information for determining benefit metric information.

Correspondingly, in the step s4′, the second device 2 obtains benefit metric request information transmitted by the first device.

Specifically, in the step s4′, the second device 2 obtains the benefit metric request information transmitted from the first device based on a predetermined communication protocol.

Herein, those skilled in the art should understand, in the centralized coordinated multipoint architecture, the benefit metric request information may be transmitted by the first device 1 to the second device, such that the second device determines the corresponding benefit metric information or CSI/RSRP information equivalent to the benefit metric information based on relevant configurations in the benefit metric request information, and transmits it to the first device. In the distributed coordinated multipoint architecture, the second device may directly determine the corresponding benefit metric information or CSI/RSRP information equivalent to the benefit metric information based on presumed or inferred coordinated multipoint simulation scenario (e.g., assume that the target base station (i.e., the first device 1) is muted), and transmit it to the first device, without a need of obtaining the benefit metric request information. For the same rationale, in the centralized coordinated multipoint architecture, the corresponding benefit metric information or CSI/RSRP information equivalent to the benefit metric information may also be directly determined by the second device without being based on the benefit metric request information and transmit to the first device.

Herein, the benefit metric information may include at least any one of the following information:
Message Type: BM request
Initiating eNB ID: INTEGER (1 . . . 4095, . . . ), for example the eNB ID of Node 1
Measurement eNB ID: INTEGER (1 . . . 4095, . . . ), for example the eNB ID of Node 2
Registration Request: ENUMERATED (start, stop, . . . ): A value set to “start”, indicates a request to start corresponding measurement report. A value set to “stop”, indicates a request to stop corresponding measurement report.
Cell To Report: indicate the cell(s) for measurement report, for example one or more cell ID for corresponding measurement report.
Cell To Measurement: indicate the interfering cell(s) for benefit measurement, for example one or more cell ID(s) for considered benefit measurement.
Reporting Periodicity: ENUMERATED, for example 5 ms, 10 ms, 20 ms, 100 ms, 1000 ms, 2000 ms, 5000 ms, 10000 ms and so on.
Partial Success Indicator: NUMERATED (partial success allowed, . . . ), Included if partial success is allowed.

It should be noted that: besides the solution above, the “Cell to Measurement” also could be RSRP threshold. For example if the RSRP reported by a UE and corresponding to a cell is no threshold less than its serving cell, then the cell is considered as interfering cell for benefit measurement.

Preferably, the benefit metric request information may also be enhanced to the resource status request information in the resource status report information employed by the current X2, so as to transmit it to the second device 2 through the first device 1.

Here, the enhancement to the resource status request information may be implemented by adding extra one or more bits in the current resource status request information, e.g., the Sixth Bit corresponding to the periodicity of the benefit metric information and/or the seventh bit corresponding to the event trigger of the benefit metric information.

The resource status request information may include, but not limited to, at least any one of the following information:
Cell To Measurement: indicate the interfering cell(s) for benefit measurement, for example one or more cell ID(s) for considered benefit measurement; here, a “measurement base station ID1” may be regarded as an “Initiating eNB ID”;
Initiating eNB ID: INTEGER (1 . . . 4095, . . . ), for example the eNB ID of Node 1; here, the functions of “measurement base station ID1” is the same as the ones of the defined “Cell To Measurement” above;
Reporting Periodicity: ENUMERATED, such as lms, 2 ms, 5 ms, 10 ms, 20 ms, 100 ms, 1000 ms, 2000 ms, 10000 ms, etc.

If the resource status request information not only includes “Initiating eNB ID,” but also includes “Cell to Measurement”; then the base station in charge of reception may also report the metric measurement report to the “Initiating eNB ID.”

In the step s1′, the second device 2 determines, based on the benefit metric request information and in conjunction with one or more coordinated multipoint simulation scenarios, benefit metric information corresponding to the coordinated multipoint simulation scenarios.

Specifically, in the step s1′, the second device 2 determines benefit metric information corresponding to the coordinated multipoint simulation scenario based on parameters in the benefit metric request information in conjunction with a coordinated multipoint simulation scenario determined based on the benefit metric request information or a coordinated multipoint simulation scenario determined based on other manners.

For example, if a registration request in the benefit metric request information is set to “start,” then in the step s1′, the second device 2 determines benefit metric information corresponding to the coordinated multipoint simulation scenario in conjunction with a coordinated multipoint simulation scenario determined based on the benefit metric request information or a coordinated multipoint simulation scenario determined based on other manners.

For another example, if the registration request in the benefit metric request information is set to “stop,” then in the step s1′, the second device 2 stops measurement and transmission of the benefit metric information.

In the step s2′, the first device 1 obtains benefit metric information transmitted by the second device based on the benefit metric request information, wherein the benefit metric information corresponds to one or more coordinated multipoint simulation scenarios.

Specifically, in the step s2′, the first device 1 interacts with the second device 2 based on the benefit metric request information according to the predetermined communication protocol, or interacts with other device capable of providing benefit metric information about the second device to obtain one or more benefit metric information of the second device.

Herein, the benefit metric information includes, but not limited to, at least any one of the following information:
Message Type: benefit metric request information or benefit metric update information(BM update)
Initiating eNB ID: INTEGER (1 . . . 4095, . . . ), for example the eNB ID of Node 1
Measurement eNB ID: INTEGER (1 . . . 4095, . . . ), for example the eNB ID of Node 2
BM Result: i.e., corresponding to various benefit metric information shown in FIG. 1.

Preferably, in the step s2′, the first device 1 could obtain, based on resource status report information corresponding to one or more second devices, benefit metric information transmitted by the second device, wherein the benefit metric information corresponds to one or more coordinated multipoint simulation scenarios.

Specifically, in the step s2′, the first device 1 may obtain the benefit metric information transmitted by the second device through enhancing the resource status update information in the resource status report information employed by the current X2.

Here, the resource status update information may be enhanced by adding extra one or more bits in the current resource status update information, for example, the Sixth Bit corresponding to the periodicity of the benefit metric information and/or the seventh bit corresponding to the event trigger of the benefit metric information.

Herein, the item of the result of the cell to measurement in the resource status update information may include benefit metric information. The benefit metric information may be determined according to the benefit metric information defined in FIG. 1.

Without the indication of the “Initiating eNB ID”, the resource status update information may use the “Measurement eNB ID1” as the “Initiating eNB ID” or including the “Initiating eNB ID” information. In the latter case, the “Measurement eNB ID1” is functionally consistent with the “Cell to Measurement” as defined above.

Preferably, in the step s1′, the second device 2 could transmit, based on the benefit metric request information and in conjunction with one or more coordinated multipoint simulation scenarios, benefit metric response information corresponding to the benefit metric request information to a first device; and then transmit, based on the benefit metric response information, benefit metric information corresponding to the benefit metric response information to the first device, wherein the benefit metric information corresponds to one or more coordinated multipoint simulation scenarios.

Correspondingly, in the step s2′, the first device could obtain benefit metric response information corresponding to the benefit metric request information according to the benefit metric request information; and then obtain benefit metric information transmitted by the second device based on the benefit metric response information, wherein the benefit metric information corresponds to one or more coordinated multipoint simulation scenarios.

Specifically, the benefit metric response information is for reporting that one or more reported targets have been successfully initialized.

Herein, the benefit metric response information includes, but not limited to, at least any one of the following information:
Message Type: BM Response
Initiating eNB ID: for example the eNB ID of Node 1
Measurement eNB ID: for example the eNB ID of Node 2
Measurement Initiation Result: Indicate which cell could be configured to report or not.

Preferably, the benefit metric response information may also be enhanced to resource status response information in the resource status report information employed in the current X2, so as to perform information transmission between the first device 1 and the second device 2.

Here, the resource status response information may be enhanced by adding extra one or more bits in the current resource status response information, e.g., the Sixth Bit corresponding to the periodicity of the benefit metric information and/or the seventh bit corresponding to the event trigger of the benefit metric information.

Herein, without the indication information for the “Initiating eNB ID”, the resource status response information may use the “Measurement eNB ID1” as the “Initiating eNB ID” or including the “Initiating eNB ID” information. In the latter case, the “Measurement eNB ID1” is functionally consistent with the “Cell to Measurement” as defined above.

Here, those skilled in the art should understand, the above benefit metric response information and/or resource status response information are all explanations in the case of successfully responding to the benefit metric request information and/or resource status request information; in case of failed response to the benefit metric request information and/or resource status request information, then the benefit metric response information and/or resource status response information may also be benefit metric failure information and/or resource status failure information.

Herein, the benefit metric failure information indicates that for none of the requested measurement objects the measurement can be initiated, the benefit metric failure information includes, but not limited to, at least any one of the following information:
Message Type: BM failure
Initiating eNB ID: INTEGER (1 . . . 4095, . . . ), for example the eNB ID of Node 1
Measurement eNB ID: INTEGER (1 . . . 4095, . . . ), for example the eNB ID of Node 2
Failure Cause: indicate the failure cause

Preferably, the benefit metric failure information may also be enhanced to resource status failure information in the resource status report information employed by the current X2, so as to perform information transmission between the first device 1 and the second device 2.

Here, the resource status failure information may be enhanced through for example adding extra one or more bits in the current resource status failure information, e.g., the Sixth Bit corresponding to the periodicity of the benefit metric information and/or the seventh bit corresponding to the event trigger of the benefit metric information.

Herein, without the indication information of the “Initiating eNB ID,” the resource status failure information may use the “Measurement eNB ID1” as the “Initiating eNB ID” or including the “Initiating eNB ID” information. In the latter case, the “Measurement eNB ID1” is functionally consistent with the “Cell to Measurement” as defined above.

For example, if cell 1 has obtained benefits through muting cell 2 and cell 3, then cell 1 is “Initiating eNB,” cell 2 is “Cell to Measurement,” and cell 1 is “Reporting cell”.

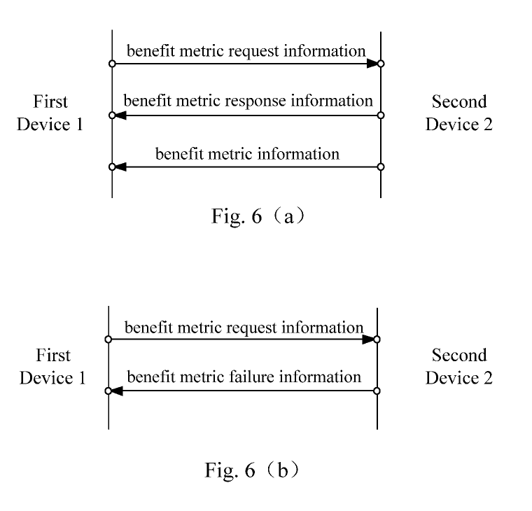

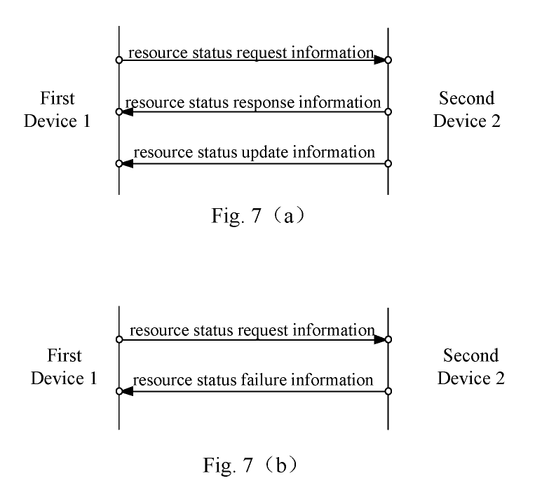

FIGS. 6 and 7 show a simplified flow diagram for resource allocation between multiple cells based on coordinated multipoint by cooperation of a first device and a second device.

According to FIG. 6, the procedure for transmitting the benefit metric information could be described as:

The first device 1 could initiate the benefit metric report from the second device 2 by sending benefit metric request information to the second device 2;

After receiving benefit metric request information from the first device 1, the second device 2 could make the decision by itself to send which kind of response information.
If the second device 2 sends benefit metric response information to the first device 1, then after that the second device 2 could send the benefit metric information by benefit metric update information according to the configuration in benefit metric request information periodically or evently;
If the second device 2 sends benefit metric failure information to the first device 1, then it means that current benefit metric request information is unsuccessful.

FIG. 7 shows transmitting benefit metric information through enhancing the resource status report information employed in the current X2, which will not be detailed here.

To those skilled in the art, apparently the present invention is not limited to the details of the aforementioned exemplary embodiments; moreover, under the premise of not deviating from the spirit or fundamental characteristics of the invention, this invention can be accomplished in other specific forms. Therefore, the embodiments should be considered exemplary and non-restrictive no matter from which point, the scope of the invention is defined by the appended claims instead of the above description, and aims at covering the meanings of the equivalent components falling into the claims and all changes within the scope in this invention. Any reference sign in the claims shall not be deemed as limiting the concerned claims. Besides, apparently the word “comprise/include” does not exclude other components or steps, singular numbers does not exclude complex numbers, the plurality of components or means mentioned in device claims may also be accomplished by one component or means through software or hardware, the wording like first and second are only used to represent names rather than any specific order.

1. A method for resource allocation between multiple cells by a first device based on coordinated multipoint, wherein the method comprises:
obtaining one or more benefit metric information with respect to a second device, wherein the benefit metric information corresponds to one or more coordinated multipoint simulation scenarios;
determining resource allocation information corresponding to an associated device associated with the benefit metric information based on the benefit metric information.

2. The method according to claim 1, wherein the method further comprises:
transmitting benefit metric request information to one or more second devices;
wherein the obtaining a comprises:
obtaining benefit metric information transmitted by the second device based on the benefit metric request information, wherein the benefit metric information corresponds to one or more coordinated multipoint simulation scenarios.

3. The method according to claim 1, wherein the obtaining comprises:
obtaining, based on resource status report information corresponding to one or more second devices, benefit metric information transmitted by the second device, wherein the benefit metric information corresponds to one or more coordinated multipoint simulation scenarios.

4. The method according to claim 1, wherein the benefit metric information includes at least any one of the following:
benefit cell indication information corresponding to the second device;
interference cell indication information corresponding to the second device;
benefit value information corresponding to the benefit cell;
interference level information corresponding to the interference cell;
benefit resource indication information corresponding to the benefit cell;
user information corresponding to the benefit cell;
measurement indication information of channel status information corresponding to the coordinated multipoint simulation scenario.

5. The method according to claim 4, wherein the benefit value information includes at least any one of the following:
percentage information of UL/DL predetermined conserved resources for the benefit cell to all UL/DL available resources;
maximum potential throughput and/or maximum potential performance corresponding to the benefit cell and/or the interference cell;
average potential throughput and/or maximum potential performance corresponding to the benefit cell and/or the interference cell;
potential throughput and/or potential performance of user devices corresponding to the benefit cell and/or the interference cell;
channel information corresponding to the benefit cell, the interference cell, the coordinated multipoint simulation scenario and/or the user device.

6. A method facilitating resource allocation between multiple cells by a second device based on coordinated multipoint, wherein the method comprises:
determining, based on one or more coordinated multipoint simulation scenarios, benefit metric information corresponding to the coordinated multipoint simulation scenario;
transmitting the benefit metric information to a first device.

7. The method according to claim 6, wherein the method further comprises:
obtaining benefit metric request information transmitted by the first device;
wherein the determining, based on one or more coordinated multipoint simulation scenarios comprises:
determining, based on the benefit metric request information and in conjunction with one or more coordinated multipoint simulation scenarios, benefit metric information corresponding to the coordinated multipoint simulation scenarios.

8. A first device for resource allocation between multiple cells based on coordinated multipoint, wherein the device comprises:
an obtaining module configured to obtain one or more benefit metric information with respect to a second device, wherein the benefit metric information corresponds to one or more coordinated multipoint simulation scenarios;
an allocation determining module configured to determine resource allocation information corresponding to an associated device associated with the benefit metric information based on the benefit metric information.

9. The first device according to claim 8, wherein the device further comprises:
a request transmitting module configured to transmit benefit metric request information to one or more second devices;
wherein the obtaining module is configured to:
obtain benefit metric information transmitted by the second device based on the benefit metric request information, wherein the benefit metric information corresponds to one or more coordinated multipoint simulation scenarios.

10. The first device according to claim 9, wherein the obtaining module is configured to:
obtain benefit metric response information corresponding to the benefit metric request information according to the benefit metric request information;
obtain benefit metric information transmitted by the second device based on the benefit metric response information, wherein the benefit metric information corresponds to one or more coordinated multipoint simulation scenarios.

11. The first device according to claim 8, wherein the obtaining module is configured to:
obtain, based on resource status report information corresponding to one or more second devices, benefit metric information transmitted by the second device, wherein the benefit metric information corresponds to one or more coordinated multipoint simulation scenarios.

12. A second device facilitating resource allocation between multiple cells based on coordinated multipoint, wherein the device comprises:
a metric determining module configured to determine, based on one or more coordinated multipoint simulation scenarios, benefit metric information corresponding to the coordinated multipoint simulation scenario;
a transmitting module configured to transmit the benefit metric information to a first device.

13. The second device according to claim 12, wherein the device further comprises:
a request obtaining module configured to obtain benefit metric request information transmitted by the first device;
wherein the metric determining module is configured to:
determine, based on the benefit metric request information and in conjunction with one or more coordinated multipoint simulation scenarios, benefit metric information corresponding to the coordinated multipoint simulation scenarios.

14. The second device according to claim 13, wherein the metric determining module is configured to:
transmit, based on the benefit metric request information and in conjunction with one or more coordinated multipoint simulation scenarios, benefit metric response information corresponding to the benefit metric request information to a first device;
transmit, based on the benefit metric response information, benefit metric information corresponding to the benefit metric response information to the first device, wherein the benefit metric information corresponds to one or more coordinated multipoint simulation scenarios.

15. A system for resource allocation between multiple cells based on CoMP, wherein the system comprises the first device according to claim 1, and a second device comprising a metric determining module configured to determine, based on one or more coordinated multipoint simulation scenarios, benefit metric information corresponding to the coordinated multipoint simulation scenario and a transmitting module configured to transmit the benefit metric information to a first device.
